(19) United States
(12) Patent Application Publication
(10) Pub. No.: US 2015/0314460 A1
(43) Pub. Date: Nov. 5, 2015

(54) SCISSORS

(71) Applicant: PLUS Corporation, Tokyo (JP)

(72) Inventors: Mitsuru Wakabayashi, Tokyo (JP); Tetsuo Kozakai, Tokyo (JP); Shinya Abe, Tokyo (JP)

(21) Appl. No.: 14/693,622

(22) Filed: Apr. 22, 2015

(30) Foreign Application Priority Data
May 2, 2014 (JP) 2014-095126

(51) Int. Cl. B26B 13/28; B26B 13/06

(52) U.S. Cl. CPC B26B 13/28; B26B 13/06

(57) ABSTRACT

To provide scissors having a smoother cut with a light feel. A pair of scissors includes two cutting members. Each cutting member includes a blade 110 having an edge, a handle having a grip, and a joint region 120. The joint regions 120 of the cutting members are pivotally joined together using a joint assembly so that the cutting members can pivotally move. Each of the edges is curved so that an angle between the edges is kept within a range between 27° and 43° when the cutting members move from an opened position forming an angle of 30° therebetween to a closed position. A contact-free part 140 which is a recess is formed in the inner surface of the blade 110. The contact-free part 140 extends beneath the joint assembly.

### CLAIM OF PRIORITY TO RELATED APPLICATION

The application claims priority from Japanese Patent Application No. 2014-095126 filed May 2, 2014, the disclosure of which is incorporated herein by reference in its entirety.

### BACKGROUND OF THE INVENTION

1. Technical Field

The present invention relates to scissors.

2. Background Art

Scissors and shears have long been used for different purposes at different places such as office places, kitchens, barber shops, and beauty shops. Tailoring shears, fabric shears, craft scissors, and food scissors are examples. (The term “scissors” is used collectively for scissors, shears, and any other cutting/shearing tools having a similar appearance, function, and configuration.)

Typical scissors include two cutting members joined together with a joint assembly so that they can be opened and closed on the joint assembly. Each cutting member includes a blade, a handle, and a joint region. The blade and the handle are opposite to each other across the joint region. The aforementioned two cutting members are joined together using the joint assembly in the joined regions of the cutting members. A user of the scissors places his or her thumb and fingers in the handles of the cutting members. He or she then closes the pivoted cutting members from their opened position to cut object that gets caught between the edges of the blades.

While a fundamental function of the scissors is to cut what gets caught, scissors having a smoother cut which can be used with a smaller force exerted during cutting are in high demand because women and children use scissors as well.

The present inventor had made studies in order to provide such scissors.

The present inventor had made studies about what makes a user of scissors feel heavier in his or her hand to open or close the cutting members and found some reasons.

One reason lies in increased friction between the cutting members. The two cutting members, which typically have a plate-like shape, pivotally move with the two blades kept in contact with each other without any gap between them in order to cut object that gets caught between the edges. A substance, if present between the cutting members or on the cutting member (s), increases the friction between them. For example, adhesive residues may build up on the cutting member(s) of office scissors after an adhesive tape is cut. Sticky gel or similar material may be caught between the cutting members when scissors are used for food. In such cases, it is hard to cut object with a smaller force.

In order to reduce the friction between the cutting members caused due to something trapped between the cutting members, it is known to provide a slight hollow ground area called “hizoko” in the opposing surfaces of the blades of the cutting members. The hollow ground areas in the blades serve to receive any foreign or unwanted substance caught between the blades of the cutting members. As a result, the friction between the cutting members sliding against each other can be suppressed to a certain degree even when an unwanted substance is caught between the blades of the cutting members.

It is, however, preferable that the cutting members can be opened and closed with a smaller force exerted by a user.

An object of the present invention is to provide scissors having a smoother cut with a light feel.

### BRIEF SUMMARY OF THE INVENTION

The present invention is a pair of scissors including two cutting members, each cutting member having a blade at a distal side thereof, the blade including an edge along a fore side thereof, a handle at a proximal side thereof, the handle including a grip, and a joint region located between the blade and the handle, the blade having an inner surface, the inner surfaces being opposite to each other, wherein at least 80% of an area of the inner surface of the blade behind the edge has a contact-free part, the contact-free part extending into the joint region; and a joint assembly for pivotally joining the cutting members together, wherein the contact-free part does not contact with an imaginary surface created by movement of the edges of the cutting members.

As described above, at least 80% of an area of the inner surface of the blade behind the edge has the contact-free part, and the contact-free part does not contact with an imaginary surface created by movement of the edges of the cutting members. Accordingly, no problem will arise to the contact between the edges of the two cutting members but there is a gap between the inner surfaces of the cutting members (i.e., between the inner surfaces of the areas where the contact-free part(s) is/are present in at least one of the two cutting members). If an unwanted substance is present between the cutting members, the substance less likely causes the increase of friction between the cutting members. A user can move the cutting members smoothly with a light feel. The contact-free parts reduce the contact area between the inner surfaces of the cutting members compared to scissors with no such contact-free parts. Accordingly, a user can move the cutting members of the scissors of the present application more smoothly with a lighter feel compared to when the entire inner surfaces of the cutting members contact with each other even when no substance is present between the cutting members.

In addition, the contact-free part in the scissors of the present invention extends into the joint region of the cutting member. The joint region is joined using the joint assembly as described above. Accordingly, each joint region of the cutting member includes a bore through which the joint assembly is passed. A plate-like member having a certain surface area is disposed around the bore. The plate-like members forming the respective joint regions typically contact with each other with their inner surfaces (usually the entire inner surfaces) are located on the extension of the aforementioned imaginary surface. If not, the relative movement of the cutting members can cause backlash. The joint regions are abutted against each other, producing friction between them. It is noted that the joint assembly of the scissors acts as the fulcrum, the handle acts as the point of load, and the joint region acts as the point of effort. The friction significantly increases the force required to be exerted to the point of load because the joint regions are close to the joint assembly. With the contact-free parts formed in the inner surfaces of the joint regions, the friction between the joint regions of the cutting members is reduced. The cutting members can thus be moved smoothly with a light feel.

The contact-free part may extend only to a position short of where the cutting members are joined together using the joint assembly in the joint region. The scissors with this configuration is less likely to be suffered from backlash when the joint regions are joined together using the joint assembly because the outer surfaces of the joint regions are flat at the positions where the joint regions are joined together.

On the other hand, the contact-free part may extend over a position where the cutting members are joined together using the joint assembly in the joint region. With this configuration, smaller areas of the inner surfaces of the joint regions are abutted against each other, reducing the friction between the joint regions.

The inner surfaces of the joint regions are contact with each other at the areas where no contact-free parts are formed. The contacted areas of the inner surfaces of the joint regions may be flat or positioned on a certain flat plane. When the contacted areas of the inner surfaces of the joint regions are completely flat, these flat surfaces are flush with an extension of the imaginary surface described later. On the other hand, when the contacted areas of the inner surfaces of the joint regions are not flat, the area of the joint region that is in contact with its counterpart is positioned on a certain flat plane. Then the contact may not be plane contact. These contacted portions of the joint regions are flush with the extension of the imaginary surface described later. Although the inner surfaces of the joint regions may be curved or angled as described below, the two joint regions can be pivotally moved without any backlash because of the aforementioned structures of the inner surfaces.

In the present application, the “inner surface” of the cutting member refers to the surfaces of the two cutting members opposite to each other. The “outer surface” of the cutting member refers to the surfaces opposite to the respective inner surfaces of the cutting members. In the present application, the “fore side” of the cutting member refers to the side of the edge of each cutting member. The “back side” of the cutting member refers to the side opposite to the fore side. In the present application, the “length” of the contact-free part refers to the length along the longitudinal direction of the cutting member. The “width” of the contact-free part refers to the dimension in the fore-to-back side direction of the cutting member.

Each edge of the cutting member of the scissors according to the present application may be a straight edge. Each edge of the cutting member of the scissors according to the present application may be curved so that an angle between the edges is kept within a range between 27° and 43° when the cutting members move from an opened position forming an angle of 30° therebetween to a closed position.

The angle between the cutting members of the scissors is varied when the cutting members are moved from the opened position to the closed position to cut object. With respect to this, according to the studies made by the present inventor, it has been found that smoothness of cut is varied depending on the angle between the cutting members. When the cutting members of the scissors are opened widely (at a larger angle between them) to cut the object close to the root of the blades, the object may slip away from the blades. It is sometimes hard to cut the object with a smaller force.

The edges of the blades of the cutting members of the present application are each curved so that the angle between the edges is kept within a range between 27° and 43° when the cutting members move from the opened position forming an angle of 30° therebetween to the closed position. Even when the angle between the cutting members is reduced gradually from 30°, the angle between the edges is not changed so much. Accordingly, a user can move the cutting members easily with a light feel regardless of the angle between the cutting members, when the cutting members are closed from the angle of 30°, which also contributes to a light feel of the scissors.

The contact-free part may be a recess formed in the inner surface of the cutting member. The contact-free part may extend widthwise to the back side of the blade. When the contact-free part is a recess formed in the inner surface of the cutting member, it is similar to a known hollow ground area called “hizoko”. Even in such cases, conventional “hizoko” is confined in the area of the inner surface of the blade. The contact-free part of the present application is thus different from the “hizoko”. On the other hand, when the contact-free part extends to the back side of the blade, this contact-free part is completely different from the “hizoko”. The edge rises from the contact-free part toward the aforementioned imaginary surface.

When the contact-free part is a recess, the outline in cross section of the inner surface of the cutting member across the contact-free part is curved toward an outer surface that is opposite to the inner surface of the cutting member, the cross section being taken in the direction perpendicular to the length of the cutting member. Alternatively, the outline in cross section of the inner surface of the cutting member across the contact-free part is defined to have an inverted rectangular U-shape toward an outer surface that is opposite to the inner surface of the cutting member, the cross section being taken in the direction perpendicular to the length of the cutting member. In addition, the outline in cross section of the inner surface of the cutting member across the contact-free part is defined to have a V-shape toward an outer surface that is opposite to the inner surface of the cutting member, the cross section being taken in the direction perpendicular to the length of the cutting member. They may be easily formed in the cutting members by machine-cutting or pressing of the cutting members.

When the contact-free part extends the outside the joint region and over the position where the joint regions of the cutting members are jointed together using the joint assembly, backlash may occur between the joint regions. When the contact-free part extends to the outside the joint region, backlash is less likely to be caused with the contact-free part formed as a recess.

An outer surface that is opposite to the inner surface of the cutting member of the scissors according to the present application may be flat. In this case, the outer and inner surfaces of the cutting member are not parallel to each other at a position where the contact-free part is not present. Such scissors may be produced by machine-cutting the inner surface of the cutting member to form the contact-free part.

An outer surface that is opposite to the inner surface of the cutting member of the scissors according to the present application may be parallel to the aforementioned inner surface. Such scissors may be produced by pressing the inner surface of the cutting member to form the contact-free part. When the outer and inner surfaces of the cutting member is parallel to each other and the contact-free part extends over the position where the joint regions are joined together using the joint assembly, the joint region is curved or angled (that is, a part of the joint region is projected outward), so that it may be hard to fix the joint assembly to the joint regions in a stable manner.

In such cases, an adjusting member is attached to the joint region, the adjustment member including a base surface contact with the outer surface of the joint region and a top surface, the base surface having a contour corresponding to the outer surface of the joint region, the top surface being flat and parallel to the imaginary surface, the joint assembly being passed through the adjusting member in a top-to-base direction. The adjustment member helps to fix the joint assembly to the joint regions in a stable manner.

Furthermore, the outer surface of the joint region may have a hole having a bottom surface that is parallel to the imaginary surface, the bottom surface being extended across a bore through which the joint assembly passes, rather than using the adjusting member. This configuration also helps to fix the joint assembly to the joint regions in a stable manner.

### BRIEF DESCRIPTION OF THE DRAWINGS

FIG. 1 is a plan view of a pair of scissors according to a first embodiment of the present invention in which cutting members are in their closed position;

FIG. 2 is a plan view of the scissors in FIG. 1 in which the cutting members are in their opened position;

FIG. 3 is a side view of the scissors in FIG. 1;

FIG. 4 is a plan view of a cutting member body of the scissors in FIG. 1;

FIG. 5 is a plan view of the scissors in FIG. 1 in which the cutting members are opened at an angle of about 30°;

FIG. 6 is a plan view of the scissors in FIG. 1 in which the cutting members are opened at an angle of about 10°;

FIG. 7 is a plan view of a cutting member body of the scissors in FIG. 1 in which the area corresponding to a contact-free part is depicted;

FIG. 8 is a cross-sectional view of blades of the scissors in FIG. 1;

FIG. 9 is a cross-sectional view of blades of the scissors in FIG. 1;

FIG. 10 is a cross-sectional view of blades of the scissors in FIG. 1;

FIG. 11 is a cross-sectional view of blades of the scissors in FIG. 1;

FIG. 12 is a cross-sectional view showing a structure of a joint assembly of the scissors in FIG. 1;

FIG. 13 is a cross-sectional view showing another structure of a joint assembly of the scissors in FIG. 1;

FIG. 14 is a cross-sectional view showing yet another structure of a joint assembly of the scissors in FIG. 1;

FIG. 15 is a cross-sectional view of blades of scissors according to a second embodiment;

FIG. 16 is a cross-sectional view of blades of a pair of scissors according to the second embodiment;

FIG. 17 is a cross-sectional view of blades of the scissors according to the second embodiment;

FIG. 18 is a cross-sectional view of blades of the scissors according to the second embodiment; and

FIG. 19 is a plan view of a cutting member body of a pair of scissors according to third and fourth embodiments in which the area corresponding to a contact-free part is depicted.

### DETAILED DESCRIPTION OF THE INVENTION

Preferred first through fourth embodiments of the present invention are described in detail with reference to the drawings.

In the following embodiments, the same or similar components are indicated with the same number, and a detailed description thereof may be omitted.

### First Embodiment

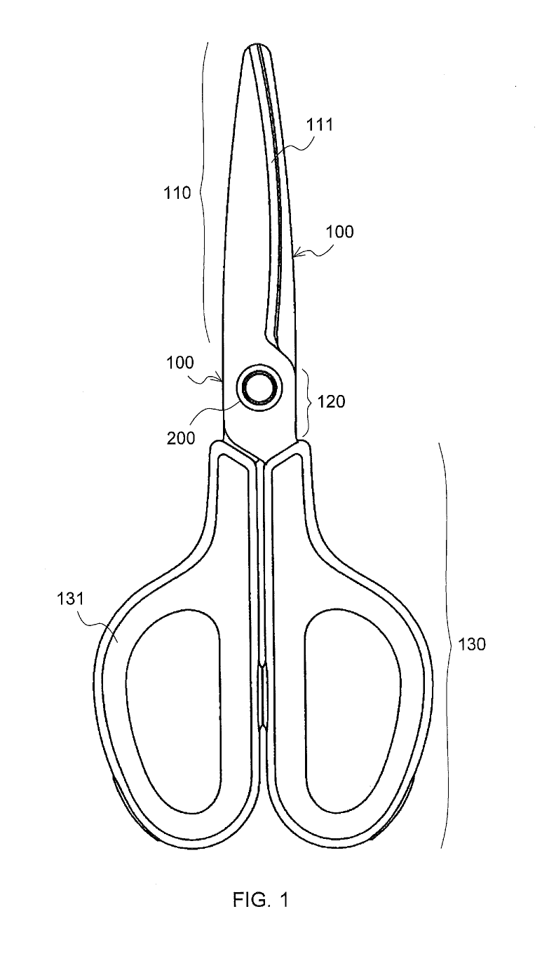

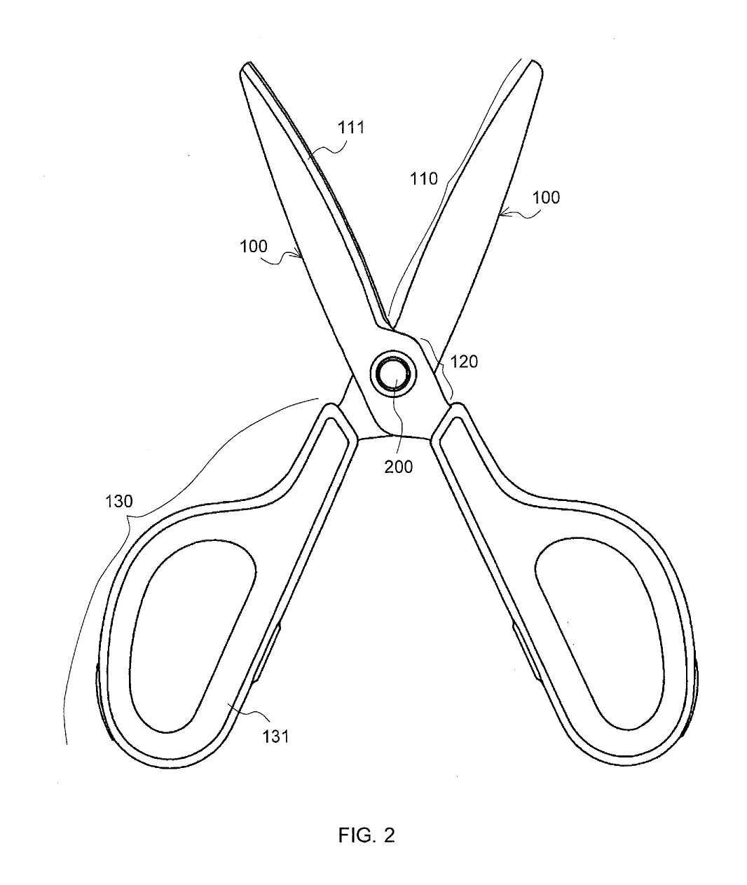

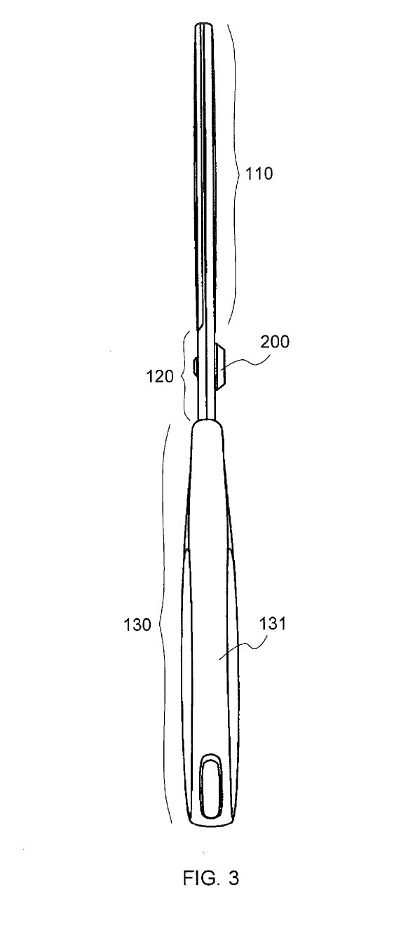

FIGS. 1 and 2 are plan views of a pair of scissors according to a first embodiment of the present invention in which cutting members described below are in their closed and opened positions, respectively, and FIG. 3 is a side view of the same scissors.

The scissors have two cutting members 100.

Each cutting member 100 includes a blade 110 at the distal side thereof, a joint region 120, and a handle 130 at the proximal side thereof.

The two cutting members 100 are pivotally joined at a joint assembly 200 in the joint region 120. In other words, the cutting members 100 can slide against each other on the joint assembly 200. How the joint regions 120 of the two cutting members 100 are joined together using the joint assembly 200 is described later.

The blades 110 are made of, for example, metal. Each blade 110 of an elongated plate-like shape comprises an edge 111. The edge 111 extends along the entire length of the blade 110 on the fore side thereof. The edge 111 of the cutting member 100 that is on top in FIGS. 1 and 2 is formed to taper in the direction from the back side to the fore side. While not being illustrated in FIGS. 1 and 2, the edge of the other cutting member 100 is also formed in the similar manner.

The joint region 120 is a plate-like portion integral with the blade 110 for connecting the blade 110 and the handle 130. The joint region 120 has a certain surface area so that the two cutting members 100 can be joined together in the joint regions 120 using the joint assembly 200. The inner surface of each joint region may be flat or not. The opposite inner surfaces of the joint regions 120 of the cutting members 100 are thus at least partially in contact with or abutted against each other. The contacted areas of the inner surfaces of the joint regions 120 may be flat or positioned on a certain flat plane. When contacted areas of the inner surfaces of the joint regions 120 are completely flat, these flat surfaces are flush with an extension of an imaginary surface described later. On the other hand, when the contacted areas of the inner surfaces of the joint regions 120 are not flat, the area of the joint region 120 that is in contact with its counterpart is positioned on a certain flat plane. These contacted portions of the joint regions 120 are flush with the extension of the imaginary surface described later. Although the inner surfaces of the joint regions 120 may be curved or angled as described below, the two joint regions 120 can be pivotally moved without any backlash because of the aforementioned structures of the inner surfaces.

Each of the handles 130 has a grip 131 that allows a user of the scissors to grip it. The grip 131 in this embodiment has a shape of a ring or a loop. The thumb of a user is placed in one grip 131 and the forefinger and the middle finger are placed in the other grip 131 when he or she uses the scissors. Each grip 131 has a size and shape suitable for that purpose. The two grips 131 in this embodiment are identical in size and shape, but not limited thereto.

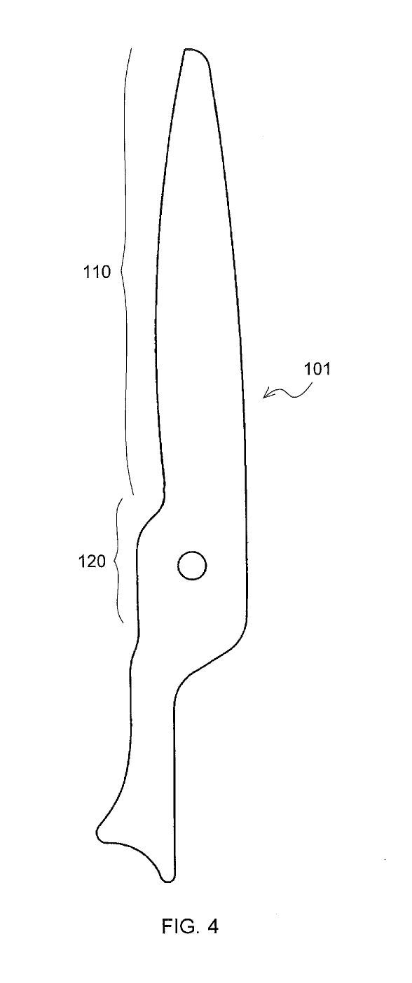

The blade 110 and the joint region 120 of each cutting member 100 are made as a single component. The material comprising the blade 110 and the joint region 120 extends to the grip 131 of the handle 130. The blade 110, the joint region 120, and the portion that extends to the grip 131 of the cutting member 100 are integrated with each other as shown in FIG. 4. The single member shown in FIG. 4 is referred to as a cutting member body 101 in this embodiment.

The edge 111 of the blade 110 may be a straight edge or a curved edge.

The edge 111 of the blade 110 in this embodiment is continuously curved, but not limited thereto. This curved design permits a user of the scissors of the first embodiment to cut object with a smaller force.

The shape of the curve is determined in such a manner that the edges 111 form an angle of 27° to 43° when the two cutting members 100 pivotally move from an opened position at an angle of about 30° to the closed position.

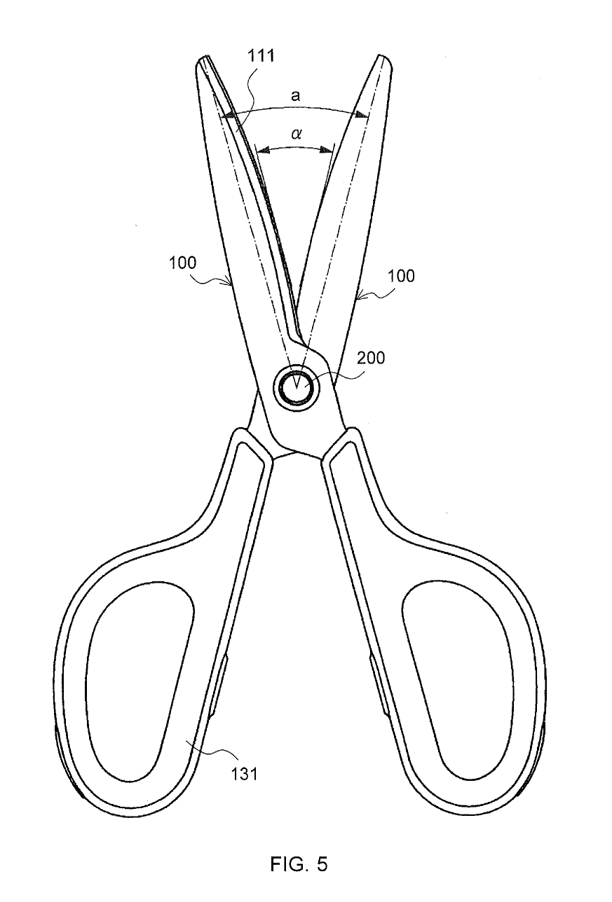

For example, FIG. 5 shows the scissors with the cutting members 100 opened at an angle of about 30°. This angle is defined by the imaginary lines running between the center of the joint assembly 200 and the tip of the respective cutting members 100, as indicated by the letter “a” in FIG. 5. The angle “a” is considered to be the angle between the cutting members 100. When the angle “a” is about 30° as shown in FIG. 5, this situation can be said that the cutting members 100 are opened at about 30° relative to each other. Another angle “a” is shown in the same figure which is the angle between the edges 111 of the two cutting members 100. The angle “a” is defined by the two tangent lines to the respective edges 111 at a position where the two edges 111 meet, with the cutting members 100 opened. The edge angle “a” is identical to or slightly smaller than the angle “a” between the cutting members 100. The angle “a” in this embodiment is 28°, but not limited thereto.

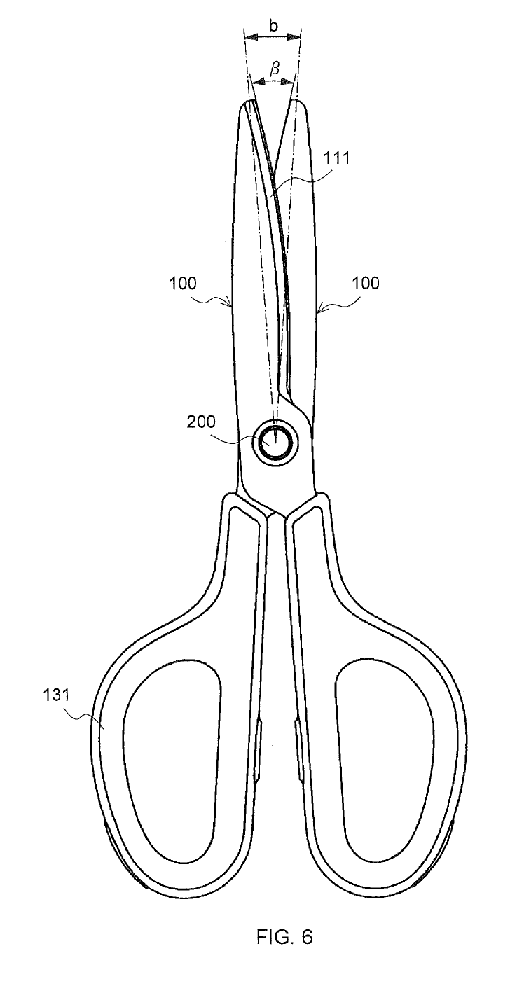

FIG. 6 shows scissors with the cutting members 100 opened at an angle of about 10°. More specifically, the angle “b” in FIG. 6 is approximately 10°. The angle “β” between the edges 111 of the cutting members 100 is significantly larger than the angle between the cutting members 100. The angle “β” in this embodiment is equal to 30°.

The curvature of each edge 111 of the cutting member 100 is determined such that the angle between the two edges 111 falls within the range between 27° and 43° regardless of the position of the cutting members 100 relative to each other at an angle between 0° (the scissors are closed) and 30°. The angle between the two edges 111 may be kept constant at a certain angle between 27° and 43° regardless of the relative position of the cutting members 100 at any angle of 0° (the scissors are closed) to 30°. Alternatively, the angle between the two edges 111 may be fluctuated but within the aforementioned range between 27° and 43° when the cutting members 100 move against each other within the range between 0° and 30°.

The two cutting members 100 have a contact-free part 140 in the opposing inner surfaces of the respective blades 110. The contact-free part 140 accounts for at least 80% of the surface area of the blade 110. The contact-free part 140 may be provided only in the blade 110. Alternatively, the contact-free part 140 may be provided both in the blade 110 and the joint region 120. The contact-free part 140 is formed “behind” the edge 111, i.e., between the edge 111 and the back side of the cutting member 100. The contact-free parts 140 are formed in such a manner that they do not contact with the imaginary surface created by movement of the edges 111 when the two cutting members 100 pivotally moves on the joint assembly 200. The contact-free part 140 is typically a concave recess or hollow area formed in the inner surface of the blade 110. The contact-free part 140 may, however, have a profile other than concave, as described below.

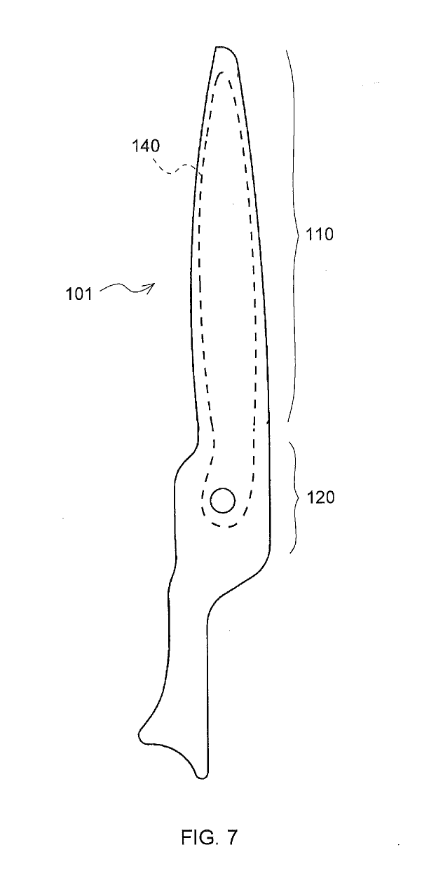

The contact-free part 140 in this embodiment is formed within the range depicted by the broken line in FIG. 7. This contact-free part 140 extends across a range spanning between the blade 110 and the joint region 120. In this embodiment, the contact-free part 140 includes the place where the two cutting members 100 are joined together with the joint assembly 200 in the joint region 120.

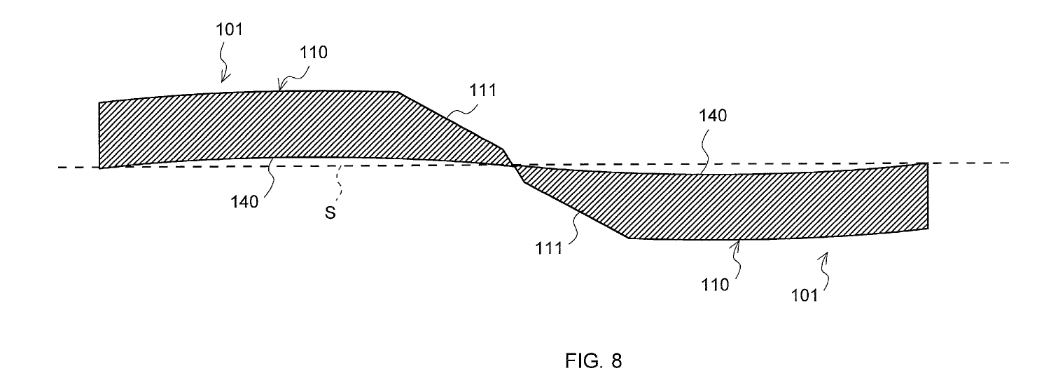

FIGS. 8 to 11 show examples of cross-sectional views of the blades 110 along with the contact-free parts 140 formed therein. More specifically, each of FIGS. 8 to 11 is an enlarged cross-sectional view of the blades 110 taken along a plane that is perpendicular to the bisector of the angle between the cutting members 100 and that passes through the point where the blades 110 meet when the cutting members 100 are opened. In the illustrated embodiment, the aforementioned point where the blades 110 meet is located at about a half of the length of the blades 110. Each of the cross-sectional views shows the blades 110, looking radially toward the pivotal axis of the cutting members 100. The cross-sectional profile of the joint region 120 is also defined in a similar way. The imaginary surface is depicted by “S” in FIGS. 8 to 11.

In the example shown in FIG. 8, the contact-free part 140 has a width spanning from a position immediately behind the tip of the edge 111 to a position just short of the back side of the blade 110. The contact-free part 140 is a recess or hollow area formed in the inner surface of the blade 110 and has across section with a gently curved outline toward the outer surface of the blade 110. In this case, except for the area where the edge 111 is present, the outer surface of the cutting member body 101 (which means the outer surfaces of the blade 110 and the joint region 120 of the cutting member body 101; the same applies to the description below) is parallel to the inner surface of the cutting member body 101 (which means the inner surfaces of the blade 110 and the joint region 120 of the cutting member body 101; the same applies to the description below). The outer surface of the cutting member body 101 is also curved outward in the width direction. More specifically, the middle portion of the cutting member body 101 in the width direction is raised outward, that is, in the direction from the inner surface to the outer surface of the cutting member body 101.

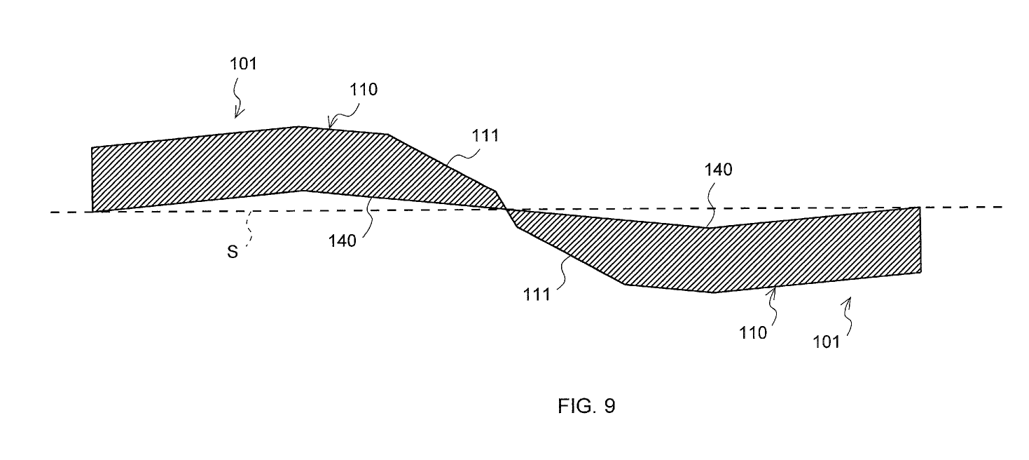

In the example shown in FIG. 9, the contact-free part 140 has a width spanning from a position immediately behind the tip of the edge 111 to a position just short of the back side of the blade 110. The contact-free part 140 is a recess or hollow area formed in the inner surface of the blade 110 and has a cross section with a V-shaped outline defined by two line segments toward the outer surface of the blade 110. In this case, except for the area where the edge 111 is present, the outer surface of the cutting member body 101 is parallel to the inner surface of the cutting member body 101. The outer surface of the cutting member body 101 is raised outward in the width direction like an obtuse ridge and the cutting member body 101 thus has an obtuse V-shaped cross section.

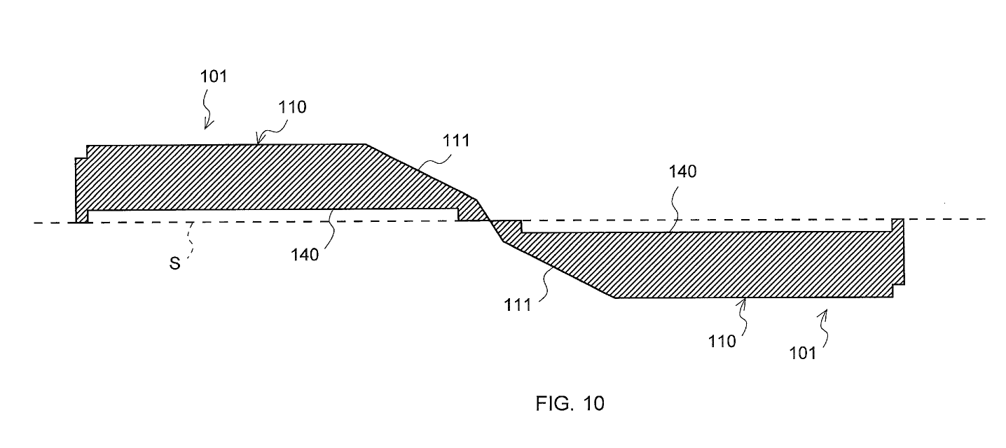

In the example shown in FIG. 10, the contact-free part 140 has a width spanning from a position slightly behind the tip of the edge 111 to a position slightly short of the back side of the blade 110. The contact-free part 140 is a recess or hollow area having a cross section with a rectangular U-shape toward the outer surface of the blade 110. In this case, except for the area where the edge 111 is present, the outer surface of the cutting member body 101 is parallel to the inner surface of the cutting member body 101. The outer surface of the cutting member body 101 in this case is flat except for the step at the back side thereof.

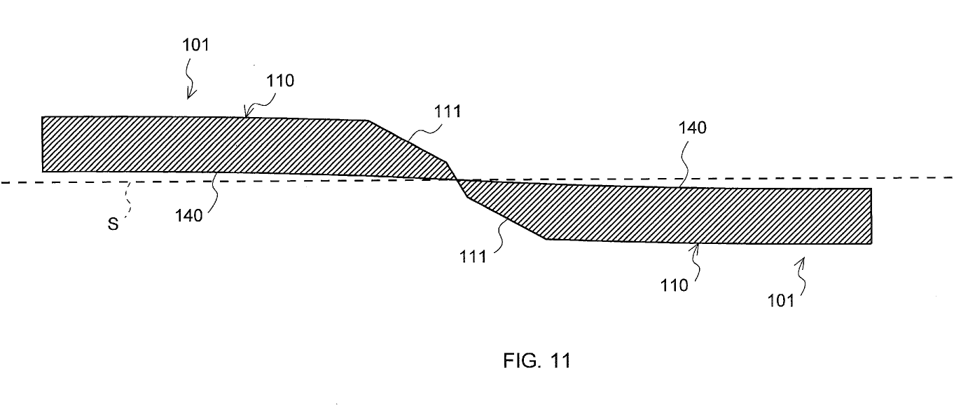

In the example shown in FIG. 11, the contact-free part 140 has a width spanning from a position immediately behind the tip of the edge 111 to the back side (outer end) of the blade 110. In other words, the outer extremity of the contact-free part 140 in the width direction reaches the outer end of the blade 110 (or the outer ends of the blade 110 and the joint region 120 in some cases). In this case, outer part of the broken line in FIG. 7 coincides with the outer outline of the cutting member body 101. The inner surface of the cutting member body 101 is gradually away from the imaginary surface “S” in the direction toward the outer surface, from the fore side to the back side of the cutting members 100, which is not necessarily so. The outline of the inner surface of the cross section of the contact-free part 140 may be defined with one or more line segments, but is curved herein. The outer surface of the cutting member body 101 in this example is parallel to the inner surface of the cutting member body 101 of the blade 110 except for the area with the edge 111. As a result, the outer surface of the cutting member body 101 is curved outward as in the inner surface of the cutting member body 101.

Next, the joint assembly of the scissors in the first embodiment is described.

The contact-free part 140 in the scissors of the first embodiment extends to the joint region 120 of the cutting member body 101 where the two cutting members 100 are joined together with the joint assembly 200, as shown in FIG. 7.

The outer surface of the cutting member body 101 is parallel to the inner surface thereof in the region corresponding to the contact-free part 140 in the scissors of the first embodiment.

When the contact-free part 140 has the cross section as shown in FIG. 10, the outer surfaces of the cutting member bodies 101 are flat at the position corresponding to the joint assembly 200 in the joint region 120 where the two cutting member bodies 101 are joined together with the joint assembly 200. On the other hand, when the contact-free part 140 has the cross section as shown in FIG. 8 or FIG. 9, the outer surfaces of the cutting member bodies 101 are not flat. The outer surfaces are curved (FIG. 8) or angled (FIG. 9) at the position corresponding to the joint assembly 200 in the joint region 120 where the two cutting member bodies 101 are joined together with the joint assembly 200. When the contact-free part 140 has the cross section as shown in FIG. 11, the outer surface of the cutting member body 101 is flat but is inclined relative to the imaginary surface at the position corresponding to the joint assembly 200.

When the outer surfaces of the cutting member bodies 101 are flat and is parallel to the imaginary surface at the position corresponding to the joint assembly 200, a well-known joint assembly may be used without any modification as the joint assembly 200.

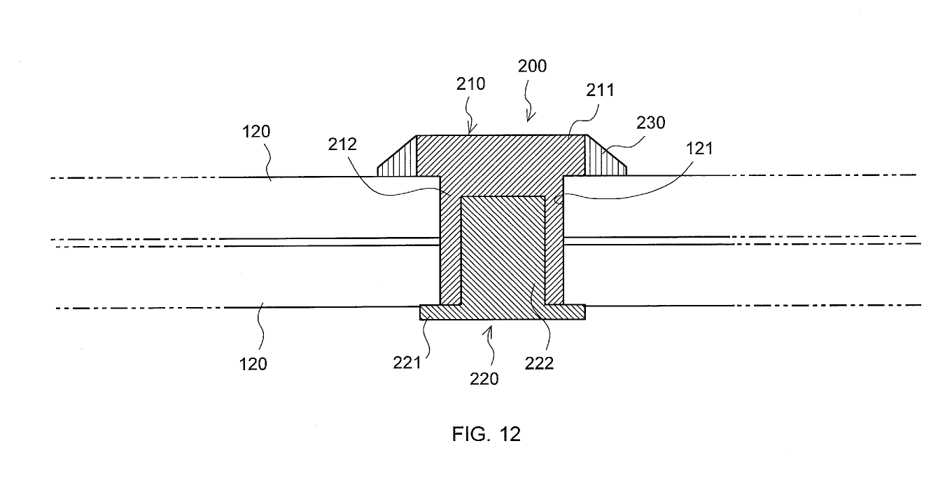

An example of the joint assembly 200 that can be used is described. The joint assembly 200 includes a first joint assembly 210 and a second joint assembly 220 (FIG. 12). The first joint assembly 210 has a disc-shaped first head 211 and a female thread 212. The first head 211 is abutted against the outer surface of one cutting member 100. The female thread 212 extends perpendicular to the first head 211. The female thread 212 has a hollow cylindrical shape and has the threaded inner surface. The female thread 212 is inserted into a bore 121 formed in the joint region 120 of the cutting member 100. More specifically, the bores 121 of the two cutting members 100 are aligned with each other in the overlapped joint regions 120. The bore 121 in this embodiment is a circular bore having the inner diameter that corresponds to the outer diameter of the female thread 212, but not limited thereto. In addition, the inner diameter of the female thread 212 is smaller than the outer diameter of the first head 211.

The second joint assembly 220 includes a disc-shaped second head 221 and a male thread 222. The second head 221 is abutted against the outer surface of the other cutting member 100. The male thread 222 extends perpendicular to the second head 221. The male thread 222 has a hollow cylindrical shape and has the threaded outer surface. The male thread 222 is threadedly engaged with the inner surface of the female thread 212. The outer diameter of the second head 221 is larger than the inner diameter of the female thread.

By threadedly engaging the outer surface of the male thread 222 of the second joint assembly 220 with the inner surface of the female thread 212 of the first joint assembly 210, the two cutting members 100 are held between the first head 211 of the first joint assembly 210 and the second head 222 of the second joint assembly 220 and allowed to pivotally move on the joint assembly 200.

A circular protection ring 230 comprising, for example, a resin material is attached around the first head 211 in this embodiment.

As described above, the outer surfaces of the cutting member bodies 101 may be curved or angled around the respective bores through which the joint assembly 200 is passed. Even in such cases, a well-known joint assembly may also be applied as the joint assembly 200, with the addition of a certain element.

The joint assembly 200 in this case includes the first joint assembly 210 and the second joint assembly 220 that are similar to those described above. However, because the outer surfaces of the cutting member bodies 101 are not flat at the position corresponding to the joint assembly 200 (i.e., around the aforementioned bore 121), a small gap is present between the first head 211 and the outer surface of the joint region 120 of one cutting member 100 or between the second head 221 and the outer surface of the joint region 120 of the other cutting member 100, which can produce backlash. A similar problem of backlash may occur when the contact-free parts 140 are formed as shown in FIG. 11. The outer surface of each cutting member body 101 is flat in the joint region 120, but is inclined relative to the imaginary surface. As a result, a small gap is also generated between the joint assembly and the outer surface of the pivot joint region, which can produce backlash.

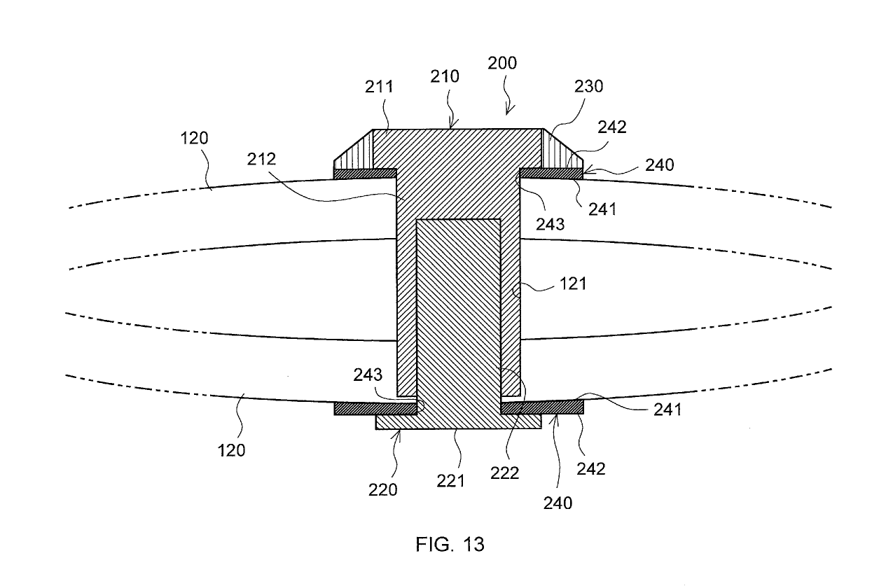

In order to avoid such backlash, the joint assembly may have, for example, adjusting members 240 as shown in FIG. 13. FIG. 13 is a cross-sectional view of the scissors with the contact-free parts 140 each having the cross section shown in FIG. 8, looking radially at a perspective from the tip of the scissors.

The adjusting members 240 are disposed on the corresponding outer surfaces of the cutting members 100. Each adjusting member 240 is a ring-shaped member having a first surface 241 and a second surface 242. The first surface 241 may closely fit to the outer surface of the cutting member 100. Alternatively, the first surface 241 may serve to absorb (or eliminate influence of) the aforementioned small gap generated due to the curved or angled profile of the outer surface. The second surfaces 242 are parallel to the imaginary surface. Each adjusting member 240 has a bore 243 that is in communication with the adjacent bore 121 formed in the joint region 120 of the cutting member 100. The aforementioned backlash can be prevented by abutting the first head 211 of the first joint assembly 210 and the second head 221 of the second joint assembly 220 against the respective second surfaces 242 of the adjusting members 240.

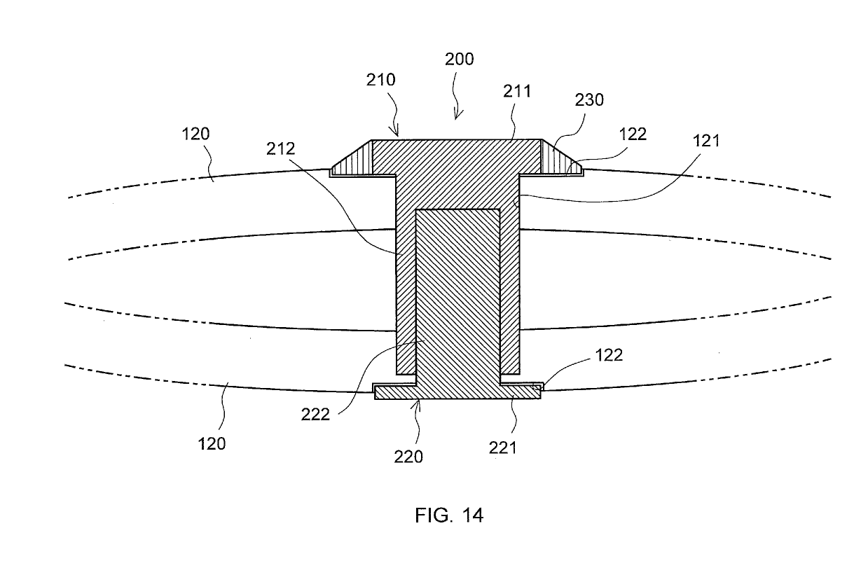

Another way of eliminating backlash is to cut and remove a portion of the cutting member 100 around the bore 121 in the joint region 120 to provide a round notch having a bottom surface 122 as shown in FIG. 14, rather than using the adjusting members 240. The notch bottom surfaces 122 are parallel to the imaginary plane as in the second surfaces 242 of the aforementioned adjusting members 240. By abutting the first head 211 of the first joint assembly 210 and the second head 221 of the second joint assembly 220 against the respective notch bottom surfaces 122, the aforementioned backlash can be avoided.

The scissors described above can be manufactured basically in the same way as typical scissors, but the following should be noted.

The aforementioned contact-free parts 140 can be formed by pressing in a mold that corresponds to the shape of the contact-free part 140 as long as an ordinary plate material having parallel faces is used as a material for the cutting member bodies 101.

In the scissors with the aforementioned notch bottom surfaces 122, each notch is formed after the cutting member body 101 is, for example, pressed to provide a curved or angled surface of the joint region 120 around the position where the bore 121 is to be formed.

Next, operation of and how to use the aforementioned scissors are described.

A user who uses the scissors of the first embodiment places his or her thumb and fingers into the grips of the handles 130 to open and close the cutting members 100 on the joint assembly 200, as in the case of using typical scissors. Object to be cut is then placed between the opened blades 110. The object is cut with the edges 111 of the blades 110 sliding against each other to their overlapped (closed) position. The inner surface of the joint region 120 of the cutting member 100 comprises a flat zone or zones. Those inner surfaces (except for the contact-free parts 140, if any in the joint regions 120) are abutted against each other at their flat zone(s). As a result, even when the edges 111 are the only areas that the blades 111 are contacted with each other, the edges 111 can smoothly move on the imaginary surface.

Since the edges 111 of the blades 110 are curved as described above, the angle between the edges 111 of the blades 110 is kept in the range between 27° and 43°, regardless of the angle between the blades 110. As a result, a user can use the scissors with a lighter feeling in his or her hand.

With the contact-free parts 140 formed in the respective inner surfaces of the blades 110, the friction between the blades 110 is less likely to be increased even when an unwanted substance is caught between the blades 110. Besides, since the inner surfaces of the blades 110 are not contacted with each other at the positions corresponding to the contact-free parts 140, there is less friction between the blades 110 in this embodiment than between the blades 110 without any contact-free parts 140 in their inner surfaces. This design also provides smoother use of the scissors with a lighter feeling in a user's hand.

In the first embodiment, each contact-free part 140 extends across the blade 110 to a certain position within the joint region 120 where the cutting members 100 are joined together with the joint assembly 200. The contact area between the inner surfaces of the joint regions 120 of the cutting members 100 is thus smaller than that in typical scissors without the aforementioned configuration. The friction between the inner surfaces of the joint regions 120 is reduced accordingly, achieving much smoother use of the scissors with a lighter feeling in a user's hand.

### Second Embodiment

A pair of scissors of the second embodiment is basically identical the one in the first embodiment.

The pair of scissors of the second embodiment includes two cutting members similar to those described in the first embodiment. The two cutting members are joined together and can pivotally move on the joint assembly.

The cutting members of the scissors of the second embodiment are identical to those in the first embodiment in that each cutting member includes a blade, a joint region and a handle and that the blade has a curved edge and the handle has a grip. The contact-free parts are formed in the respective cutting members and the areas where the contact-free parts are provided are identical to those in the first embodiment.

The only difference between the scissors in the second embodiment and the scissors in the first embodiment lies in the cross-sectional shape of the cutting member bodies.

The outer surface and the inner surface of the cutting member are parallel to each other in the blade and the joint region in the first embodiment, but the corresponding outer and inner surfaces in this embodiment are not.

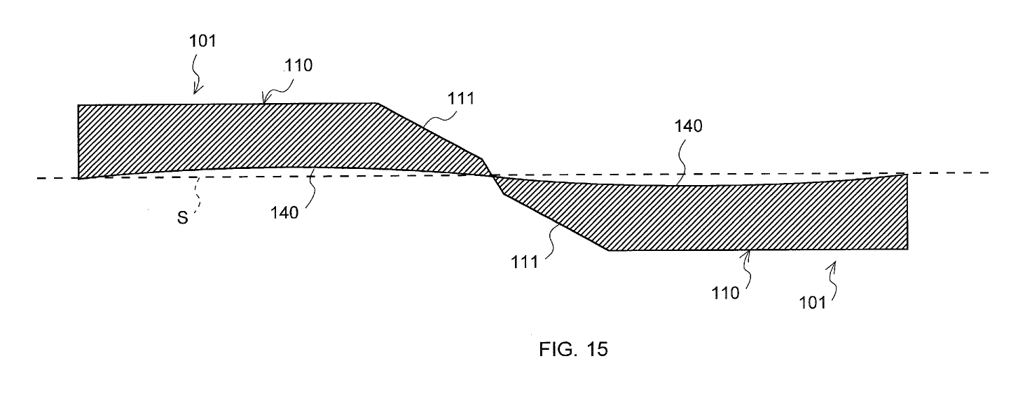

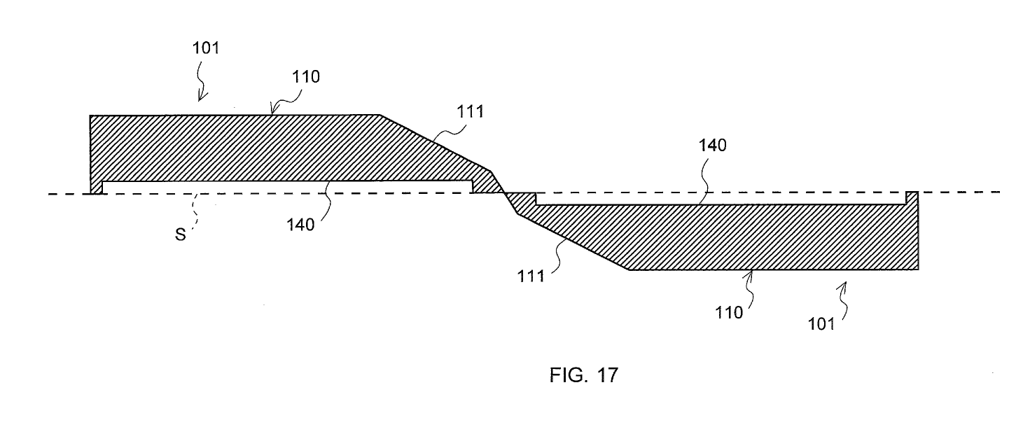

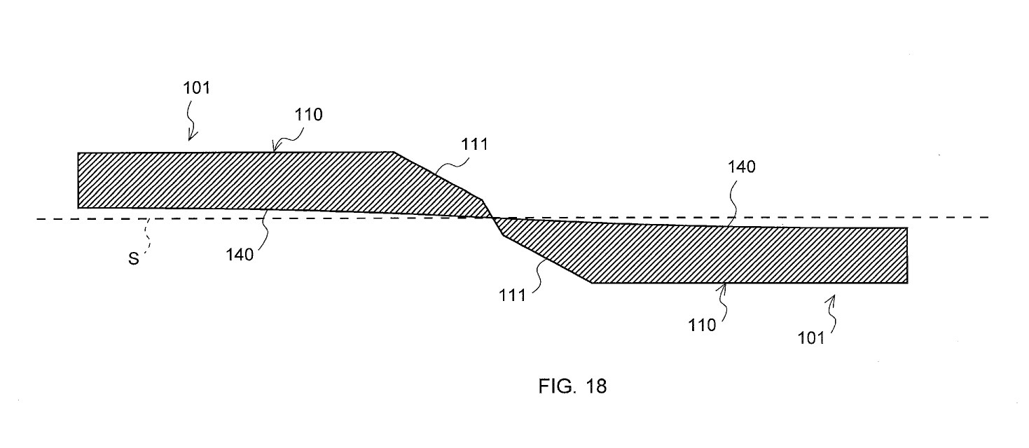

In the second embodiment, FIGS. 15 to 18 show cross-sectional views of the blades 110 along with the contact-free parts 140 formed therein. Each of the cross-sectional views in FIGS. 15 to 18 is taken along a plane in a similar manner to the cross-sectional views in FIGS. 8 to 11 and shows the blades 110, looking radially toward the pivotal axis of the cutting members 100. The cross-sectional profile of the joint region 120 is also defined in a similar way. The imaginary surface is depicted by “S” in FIGS. 15 to 18.

In the example shown in FIG. 15, the shape of the contact-free parts 140, i.e., the outline of the inner surfaces of the cutting member bodies 101 is identical to the one shown in FIG. 8. On the contrary, the outer surfaces of the cutting member bodies 101 are different from those in FIG. 8. The outer surfaces of the cutting member bodies 101 in the second embodiment are parallel to the imaginary surface “S”.

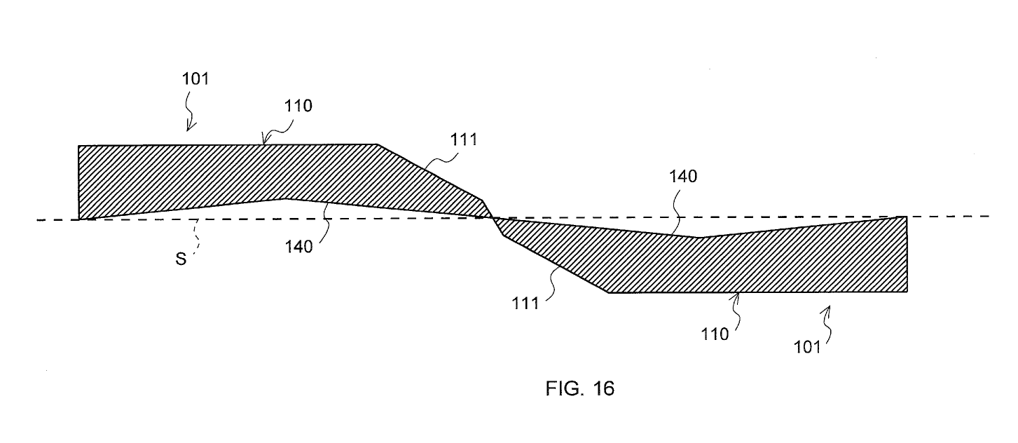

Likewise, in the examples shown in FIGS. 16, 17, and 18, the shape of the contact-free parts 140, i.e., the outline of the inner surfaces of the cutting member bodies 101 is identical to those shown in FIGS. 9, 10, and 11, respectively, except that the outer surfaces of the cutting member bodies 101 in FIGS. 16 to 18 are parallel to the imaginary surface “S”.

Each contact-free part of the second embodiment extends across the bore through which the joint assembly passes, as in the first embodiment. However, a typical joint assembly may be used without any modification thereof or with no additional element in the second embodiment because the outer surfaces of the respective joint regions are flat as described above.

The scissors in the second embodiment can be manufactured basically in the same way as typical scissors, but the following should be noted.

The aforementioned contact-free parts 140 can be formed by machine-cutting, honing or grinding as long as an ordinary plate material having parallel faces is used as a material for the cutting member bodies 101.

Next, operation of and how to use the aforementioned scissors are described.

The way of using the scissors according to the second embodiment is not different from the one in the first embodiment.

The curved design of the blade 110 in the second embodiment also results in smoother use of the scissors with a lighter feeling in a user's hand, as in the case of the first embodiment.

In addition, the effect of the reduced friction achieved by using the contact-free parts 140, especially when an unwanted substance is caught between the blades 110, is similar to the one achieved in the first embodiment. The contribution of the contact-free parts 140 to the usability of the scissors including feeling in hand is also similar to the one in the first embodiment.

### Third Embodiment

A pair of scissors of the third embodiment is basically identical to the one in the first embodiment.

The pair of scissors of the third embodiment includes two cutting members similar to those described in the first embodiment. The two cutting members are joined together and can pivotally move on the joint assembly.

The cutting members of the scissors of the third embodiment are identical to those in the first embodiment in that each cutting member includes a blade, a joint region and a handle and that the blade has a curved edge and the handle has a grip. The contact-free parts are formed in the respective cutting members and the outer surface and the inner surface of each cutting member body are parallel to each other, as in the first embodiment.

The only difference between the scissors in the third embodiment and the scissors in the first embodiment lies in coverage of the contact-free parts.

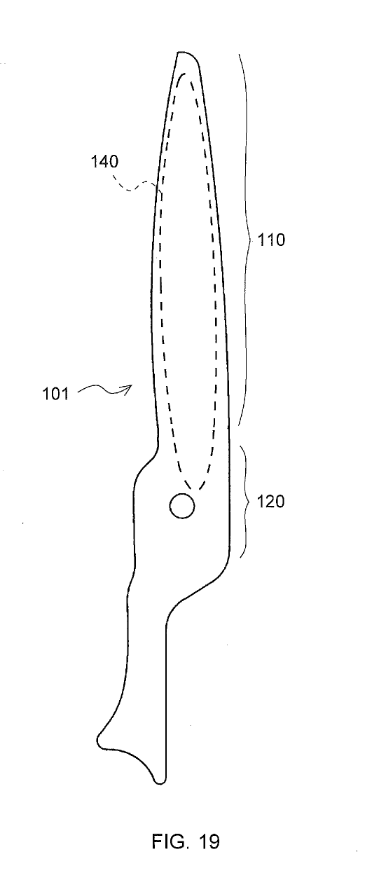

The contact-free parts 140 in the first embodiment are formed in the respective blades 110 and the joint regions 120 and extend across the respective bores 121 through which the joint assembly 200 is passed to join the cutting members 100 together. The contact-free parts 140 in the third embodiment, however, do not include the position corresponding to the respective bores 121. More specifically, each contact-free part 140 extends from the blade 110 to the joint region 120 of the cutting member 100 as in the first embodiment, but is terminated before it reaches the position corresponding to the joint assembly 200 in the joint region 120 (FIG. 19).

Each contact-free part of the scissors of the third embodiment does not reach the position of the bore through which the joint assembly passes. A typical joint assembly as shown in FIG. 12 may thus be used with no additional element or without any modification because the outer surfaces of the respective joint regions are flat at the position corresponding to the joint assembly.

A manufacturing process and important issues for the scissors in the third embodiment are similar to those described in conjunction with the first embodiment.

Operation of and how to use the scissors in the third embodiment are similar to those described in conjunction with the first embodiment.

As described above, the contact-free parts 140 do not reach the position corresponding to the joint assembly 120. The scissors with such shorter contact-free parts in the third embodiment can be slightly heavier and require a user to exert more force than the scissors in the first embodiment when he or she uses the scissors.

### Fourth Embodiment

A pair of scissors of the forth embodiment is basically identical to the one in the second embodiment.

The difference between the scissors in the fourth embodiment and the scissors in the second embodiment lies in coverage of the contact-free parts. The relationship between the contact-free areas of the fourth and second embodiments can be applied to the relationship between the contact-free areas of the third and first embodiments.

More particularly, each contact-free part 140 formed in the blade 110 and the joint region 120 of the cutting member 100 in the fourth embodiment does not reach the position corresponding to the joint assembly 200 in the joint region 120 (FIG. 19), as in the third embodiment.

The outer surface and the inner surface of the cutting member body 101 in the fourth embodiment are not parallel to each other as in the second embodiment. Instead, the outer surfaces of the cutting member bodies 101 are parallel to the aforementioned imaginary surface. A typical joint assembly as shown in FIG. 12 may thus be used with no additional element or without any modification.

A manufacturing process and important issues for the scissors in the fourth embodiment are similar to those described in conjunction with the second embodiment.

Operation of and how to use the scissors in the fourth embodiment are similar to those described in conjunction with the second embodiment.

As described above, the contact-free parts 140 do not reach the position corresponding to the joint assembly 120. The scissors with such shorter contact-free parts in the fourth embodiment can be slightly heavier and require a user to exert more force than the scissors in the second embodiment when he or she uses the scissors.

1. A pair of scissors comprising:
two cutting members, each cutting member comprising
a blade at a distal side thereof, the blade comprising an edge along a fore side thereof,
a handle at a proximal side thereof, the handle comprising a grip, and
a joint region located between the blade and the handle,
the blade having an inner surface, the inner surfaces being opposite to each other, wherein at least 80% of an area of the inner surface of the blade behind the edge has a contact-free part, the contact-free part extending into the joint region; and
a joint assembly for pivotally joining the cutting members together, wherein
the contact-free part does not contact with an imaginary surface created by movement of the edges of the cutting members.

2. The pair of scissors according to claim 1, wherein the contact-free part extends to a position short of where the cutting members are joined together using the joint assembly in the joint region.

3. The pair of scissors according to claim 1, wherein the contact-free part extends over a position where the cutting members are joined together using the joint assembly in the joint region.

4. The pair of scissors according to claim 1, wherein the contact-free part is a recess formed in the inner surface of the cutting member.

5. The pair of scissors according to claim 4, wherein the outline in cross section of the inner surface of the cutting member across the contact-free part is curved toward an outer surface that is opposite to the inner surface of the cutting member, the cross section being taken in the direction perpendicular to the length of the cutting member.

6. The pair of scissors according to claim 4, wherein the outline in cross section of the inner surface of the cutting member across the contact-free part is defined to have an inverted rectangular U-shape toward an outer surface that is opposite to the inner surface of the cutting member, the cross section being taken in the direction perpendicular to the length of the cutting member.

7. The pair of scissors according to claim 4, wherein the outline in cross section of the inner surface of the cutting member across the contact-free part is defined to have a V-shape toward an outer surface that is opposite to the inner surface of the cutting member, the cross section being taken in the direction perpendicular to the length of the cutting member.

8. The pair of scissors according to claim 1, wherein the contact-free part extends widthwise to the back side of the blade.

9. The pair of scissors according to claim 1, wherein an outer surface that is opposite to the inner surface of the cutting member is flat.

10. The pair of scissors according to claim 1, wherein an outer surface that is opposite to the inner surface of the cutting member is parallel to the inner surface of the same cutting member.

11. The pair of scissors according to claim 10, wherein an adjusting member is attached to the joint region, the adjustment member comprising abase surface contact with the outer surface of the joint region and a top surface, the base surface having a contour corresponding to the outer surface of the joint region, the top surface being flat and parallel to the imaginary surface, the joint assembly being passed through the adjusting member in a top-to-base direction.

12. The pair of scissors according to claim 10, wherein the outer surface of the joint region has a hole having a bottom surface that is parallel to the imaginary surface, the bottom surface being extended across a bore through which the joint assembly passes.

13. The pair of scissors according to claim 1, wherein each of the edges of the two cutting members is curved so that an angle between the edges is kept within a range between 27° and 43° when the cutting members move from an opened position forming an angle of 30° therebetween to a closed position.

14. A method of manufacturing a pair of scissors of claim 9, comprising forming each contact-free part by machine-cutting the inner surface of the cutting member.

15. A method of manufacturing a pair of scissors of claim 10, comprising forming each contact-free part by pressing the inner surface of the cutting member.
